(19) United States
(12) Patent Application Publication
(10) Pub. No.: US 2016/0295301 A1
(43) Pub. Date: Oct. 6, 2016

(54) COMMUNICATION PROTOCOL CONTROL METHOD AND DEVICE IN SMART TV APPARATUS

(71) Applicant: LE SHI ZHI XIN ELECTRONIC TECHNOLOGY (TIANJIN) LIMITED, Beijing (CN)

(72) Inventor: Guoliang ZHANG, Beijing (CN)

(21) Appl. No.: 15/038,013

(22) PCT Filed: Nov. 18, 2014
(86) PCT No.: PCT/CN2014/091394

§ 371 Date: May 19, 2016

(30) Foreign Application Priority Data
Nov. 21, 2013 (CN) 201310588628.3

(51) Int. Cl. H04N 21/81; H04N 21/647; H04N 21/443; H04N 21/643

(52) U.S. Cl. CPC H04N 21/818; H04N 21/643; H04N 21/647; H04N 21/443

(57) ABSTRACT

Communication protocols corresponding to connection modes are preset in a smart TV apparatus. A communication protocol control method includes: when a mode switching request from a user is received through a preset user operation entry, determining a target communication protocol corresponding to the target connection mode needing to be switched to; interrupting a current network connection between the smart TV apparatus and a router; clearing a first application corresponding to the current communication protocol from a network card chip of the smart TV apparatus, and writing a second application corresponding to the target communication protocol in the network card chip; configuring network connection parameters of the smart TV apparatus by using the target communication protocol; and re-establishing the network connection between the smart TV apparatus and the router. The method is used for solving the problem of compatibility of software and hardware and also increasing a network rate.

### CROSS-REFERENCE TO RELATED APPLICATIONS

The present disclosure is based upon and claims priority to Chinese Patent Application No. 201310588628.3, filed on Nov. 21, 2013, the entire contents of which are incorporated herein by reference.

### FIELD OF TECHNOLOGY

The present disclosure relates to the field of routers, and in particular relates to a communication protocol control method and device in a smart TV apparatus.

### BACKGROUND

With large-area intelligent development of mobile phones and tablet computers, smart TVs also gradually go into our lives. The smart TVs, just like smart phones, each have a full-open platform carrying an operating system, and users can install and uninstall applications such as software and games by themselves. Additionally, the smart TVs also can realize mutual control or data transmission with other electronic devices (e.g., mobile terminals such as mobile phones and tablet computers). However, under the promise that the smart TVs and other electronic devices are connected to the same local area network, routers are required for use. As the existing routers generally have a wireless function, the above purpose can be achieved in such a way that the smart TVs and other electronic devices access the network through the same WiFi hotspot.

Electronic devices on the market at present are frequently upgraded, and particularly, mobile terminal products and tablet computer products emerge continuously to satisfy the pursuits of consumers for new functions and new styles. The smart TVs also face the same problem; with increasingly upgrading of software systems and hardware systems of new products, new communication protocols also are increasingly issued to meet data requirements and rate requirements of network communications.

However, as router products generally are not products that users are interested in, users generally will not actively upgrade the routers as long as data transmission is normal; for this reason, it may result in that old wireless routing devices are possible to fail in meeting the requirements of new communication protocols; for example, some smart TVs are incompatible with some wireless routers, causing a phenomenon that the smart TVs cannot be connected to WiFi, and consequently, the smart TVs cannot obtain data from servers through the networks or interacting with other electronic devices; or, in some cases, although the smart TVs utilizing new communication protocols can be connected to WiFi, it may cause problems of overhigh load and the like for the routers because the new communication protocols have the characteristics of higher efficiency and the like.

Hence, it is a problem urgent to solve at present that how to make the smart TVs be better compatible with the routers.

### SUMMARY

To solve the problem that network protocols are incompatible with wireless routers of new and old styles, the present disclosure provides a communication protocol control method in a smart TV apparatus, wherein a plurality of communication protocols corresponding to a plurality of connection modes are preset in the smart TV apparatus; the method comprises:

when a mode switching request from a user is received through a preset user operation entry, determining the target communication protocol corresponding to the target connection mode needing to be switched to;

interrupting a current network connection between the smart TV apparatus and a router;

clearing a first application corresponding to the current communication protocol from a network card chip of the smart TV apparatus, and writing a second application corresponding to the target communication protocol in the network card chip of the smart TV apparatus;

configuring network connection parameters of the smart TV apparatus by using the target communication protocol; and

re-establishing the network connection between the smart TV apparatus and the router.

Preferably, before interrupting the current network connection between the smart TV apparatus and the router, the method further comprises:

obtaining user configuration information saved in the smart TV apparatus and needed by logging in the router;

the re-establishing the network connection between the smart TV apparatus and the router comprises:

re-establishing the network connection between the smart TV apparatus and the router according to the user configuration information.

Preferably, before interrupting the current network connection between the smart TV apparatus and the router, the method further comprises:

obtaining information of an application which is in a network communication through a wireless network at present in the smart TV apparatus and saving network operation data of the above application;

the re-establishing the network connection between the smart TV apparatus and the router comprises:

re-loading the application according to the saved network operation data of the application.

Preferably, the connection modes include a stable mode and a high-rate mode, wherein the stable mode corresponds to a communication protocol suitable for low-rate transmission, while the high-rate mode corresponds to a communication protocol suitable for high-rate transmission.

Preferably, when the target connection mode is the high-rate mode, the network connection parameters are configured by using a preset acceleration protocol; when the target connection mode is the stable mode, the network connection parameters corresponding to the acceleration protocol are cleared.

Preferably, after re-establishing the network connection between the smart TV apparatus and the router when the target connection mode is the high-rate mode, the method further comprises:

detecting whether the load of the router exceeds a set threshold; and

if the load exceeds the set threshold, reminding the user of re-switching the connection mode to the stable mode.

The present disclosure also provides a communication protocol control device in a smart TV apparatus, wherein a plurality of communication protocols corresponding to a plurality of connection modes are preset in the smart TV apparatus; the device comprises:

a target communication protocol determination unit for determining the target communication protocol corresponding to the target connection mode needing to be switched to when a mode switching request from a user is received through a preset user operation entry;

an interruption unit for interrupting a current network connection between the smart TV apparatus and a router;

an application switching unit for clearing a first application corresponding to the current communication protocol from a network card chip of the smart TV apparatus, and writing a second application corresponding to the target communication protocol in the network card chip of the smart TV apparatus;

a parameter configuration unit for configuring network connection parameters of the smart TV apparatus by using the target communication protocol; and

a network connection establishment unit for re-establishing the network connection between the smart TV apparatus and the router.

Preferably, the device further comprises a user configuration information obtaining unit, wherein before the interruption unit interrupts the current network connection between the smart TV apparatus and the router,

the user configuration information obtaining unit obtains user configuration information saved in the smart TV apparatus and needed by logging in the router;

the network connection establishment unit re-establishes the network connection between the smart TV apparatus and the router according to the user configuration information obtained by the user configuration information obtaining unit.

Preferably, the device further comprises an application information obtaining unit, wherein before the interruption unit interrupts the current network connection between the smart TV apparatus and the router:

the application information obtaining unit obtains information of an application which is in a network communication through a wireless network at present in the smart TV apparatus and saves network operation data of the above application;

the network connection establishment unit is used for re-loading the application according to the network operation data of the application saved by the application information obtaining unit.

Preferably, the connection modes include a stable mode and a high-rate mode, wherein the stable mode corresponds to a communication protocol suitable for low-rate transmission, while the high-rate mode corresponds to a communication protocol suitable for high-rate transmission.

Preferably, when the target connection mode is the high-rate mode, the parameter configuration unit configures network connection parameters by using a preset acceleration protocol; when the target connection mode is the stable mode, the parameter configuration unit clears the network connection parameters corresponding to the acceleration protocol.

Preferably, the device further comprises:

a threshold detection unit and a reminding unit,

wherein when the target connection mode is the high-rate mode, and after the network connection unit re-establishes the network connection between the smart TV apparatus and the router,

the threshold detection unit detects whether the load of the router exceeds a set threshold; and

the reminding unit reminds the user of re-switching the connection mode to the stable mode if a judgment that the load exceeds the set threshold is made.

The present disclosure provides a method for switching wireless communication protocols so that users can select appropriate wireless communication protocols according to their own wireless router models to adapt to the performances of the used wireless routers. In this way, overload of old-style wireless routers caused by new protocols is effectively avoided; meanwhile, new-style routers can be configured with high-rate communication protocols for use so that high performances of the new-style routers can be utilized; as a result, not only is the compatibility problem of software and hardware solved, but also network rates are increased.

### BRIEF DESCRIPTION OF THE DRAWINGS

FIG. 1 is a flow diagram of a communication protocol control method of the present disclosure; and

FIG. 2 is a schematic diagram of a communication protocol control device of the present disclosure.

### DESCRIPTION OF THE EMBODIMENTS

To make the purposes, features and advantages of the present disclosure more obviously understandable, the present disclosure is further descried in detail below in combination with accompanying drawings and specific implementation manners.

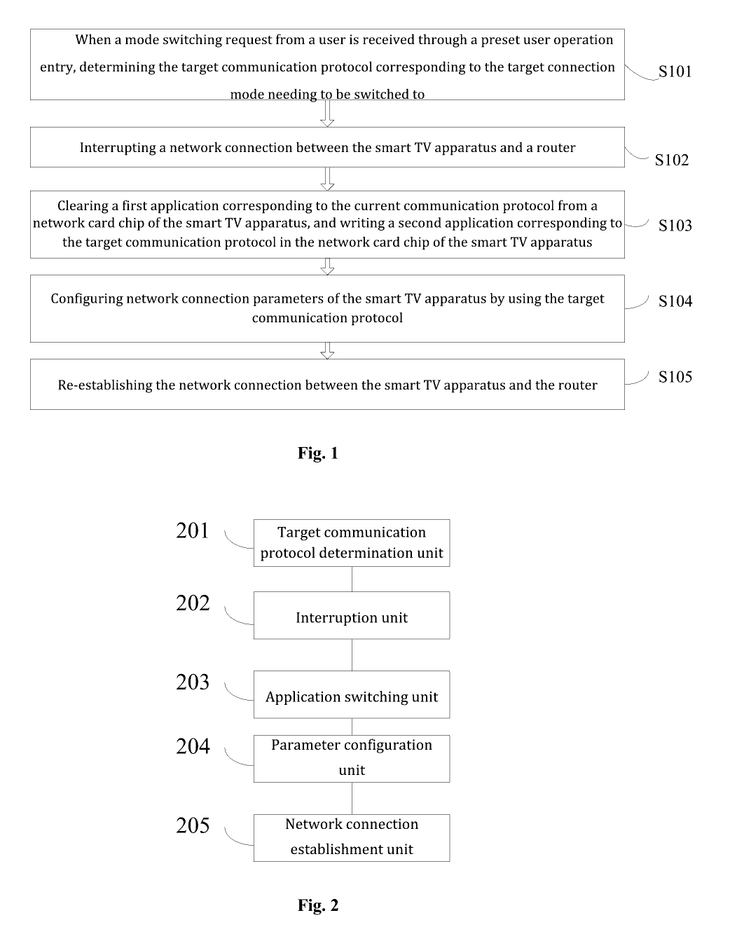

Referring to FIG. 1, a communication protocol control method in a smart TV apparatus of the present disclosure is illustrated, firstly, a plurality of wireless communication protocols, such as IEEE 802.11b, IEEE 802.11g and IEEE802.11n of IEEE 802.11 series, need to be preset in an operating system of the smart TV apparatus.

IEEE 802.11b is a standard of a wireless local area, and has a carrier frequency of 2.4 GHz and a transmission rate of 11 Mbit/s; it is the lowest in rate amongst all wireless communication protocols, and certainly also the most popular wireless protocol supporting almost all wireless routers at present.

IEEE 802.11g is a successive standard to IEEE 802.11b and has a transmission rate of 54 Mbit/s; it is the most mainstream wireless protocol at present and has higher rate and better penetrability than 802.11b. Devices of 802.11g are compatible with 802.11b.

IEEE 802.11n is a network protocol that was early called MIMO, and has the characteristics of high rate, wonderful penetrability and the like.

The wireless communication protocols can be divided into a protocol suitable for a stable mode and a protocol suitable for a high-rate mode by the transmission rates thereof. The stable mode corresponds to a communication protocol suitable for low-rate transmission, such as IEEE 802.11b; the high-rate mode corresponds to a communication protocol suitable for high-rate transmission, such as IEEE 802.11n and IEEE 802.11g.

The following operations can be continued after the plurality of protocols different in performances are preset:

S101. When a mode switching request from a user is received through a preset user operation entry, the target communication protocol corresponding to the target connection mode needing to be switched to is determined.

A wireless network mode switching function is set in system settings of the smart TV and can be set by the user through a plurality of operation entries; for example, an operation interface menu of the smart TV is opened through a remote controller of the smart TV and then a system setting submenu is further found out to switch modes. Or, a voice operation entry is set on the smart TV and the function option is found out in a voice inputting manner.

After a background wireless network application of the smart TV receives a switching command from the user, whether the mode is the high-rate mode or the stable mode is determined; if it is the high-rate mode, a path corresponding to the network protocol corresponding to the high-rate mode is found out from the pre-stored wireless network communication protocols; if it is the stable mode, a path corresponding to the network protocol corresponding to the stable mode is found out from the pre-stored wireless network communication protocols.

S102. A current network connection between the smart TV apparatus and a router is interrupted.

After the mode switching request is received, equivalently, the network connection with the router needs to be re-established; hence, the network connection therebetween needs to be interrupted firstly. It should be noted that, in actual application, the router is generally configured with user configuration information, for example, user name information, and the user can differentiate different wireless signal sources provided by different routers, etc., by means of the user name information; in addition, for the private router device of the user, in order to prevent strangers from using the network resources thereof, password information is generally set in the user configuration information, and when other terminal devices intend to access to the network through the router, firstly, the correct password is needed for verification. Hence, in case that the user configuration information is set in the router, it further needs to learn such user configuration information when the network connection with the router is re-established.

Specifically, under one implementation circumstance, an input box or the like can be popped up when the network connection with the router is re-established, such that the user inputs the user configuration information in the router. Or, in another implementation way, in consideration of the fact that the connection between the smart TV and the router has been established before, as generally, the smart TV will locally save the user configuration information used when the network connection is established last time, the user configuration information saved in the network of the smart TV and needed for logging in the wireless router also can be directly obtained before the current network connection with the router is interrupted so as to reduce the operation cost of the user, and then the user configuration information is recorded.

Additionally, if applications in network communications through a wireless network are still running in the smart TV before the network connection is interrupted, the current state data and various parameter data of the applications also can be saved; for example, if it is an opened webpage, information such as webpage content being browsed at present and HTTP address needs to be saved so that the above application is re-loaded according to the saved data and parameters after the network is reconnected. In this way, loss of current data due to network protocol switching can be effectively avoided; before and after switching, for the user, the network applications used by the user almost have no change and the user does not feel network communication stop and rate reduction due to switching; as a result, the experience value of the user is comprehensively improved.

After the user configuration information and the data of the applications running through the wireless network at present, the network connection between the smart TV and the router is interrupted.

S103. A first application corresponding to the current communication protocol is cleared from a network card chip of the smart TV apparatus, and a second application corresponding to the target communication protocol is written in the network card chip of the smart TV apparatus.

First, an entry address of a protocol configuration application of the network card chip can be searched; an application corresponding to the current communication protocol is uninstalled and an application corresponding to the target communication protocol is invoked and enabled. Second, the target communication protocol is opened and transmitted to the network card chip; if the network card chip is available at this moment, it can receive a transmitted target driving program and notify the operating system that the target driving program has been received. Next, the address of the network card chip is enabled to correspond to the address of the target communication protocol; the target communication protocol will provide various parameters for the system to set parameters of the network card chip, and parameters provided by the target communication protocol are saved for later use.

S104. Network connection parameters of the smart TV apparatus are configured by using the target communication protocol.

The system calls out the user configuration information saved in the network of the smart TV and used for logging in the wireless router and the parameters provided by the target communication protocol, and re-configures various network parameters, such as a network name, a network scene and encrypted selection information, according to the architecture of the target communication protocol; and an IP (Internet Point) address and a subnet mask as well as gateway information are set; finally, a DNS (Domain Name System) and a WINS (Windows Internet Name Server) can be configured.

S105. The network connection between the smart TV apparatus and the router is re-established.

The network connection between the smart TV apparatus and the router is re-established according to the user configuration information needed for logging in the wireless router, such as the user name or the password, and all the data of all the applications in network communications by using the wireless router is re-loaded by use of the application related data saved in S102.

In the embodiments of the present disclosure, the appropriate wireless communication protocols can be selected according to the user requests to adapt to the performances of the used wireless routers. When the wireless router used by the user is the old-style wireless router, the communication protocol relatively low in performance is selected such that overload of the old-style wireless router caused by the high-rate protocol can be effectively avoided; when the wireless router used by the user is relatively high in performance, the high-rate mode can be selected to configure the high-rate communication protocol for use so that the high performance of the new-style router can be utilized; as a result, the compatibility problem of software and hardware is effectively solved, and meanwhile, the rate of the network is also increased.

On the basis of embodiment 1, in order to enhance the experience of the user, increase the utilization rate of wireless resources and more flexibly switch between the high-rate protocol and the low-rate protocol, a plurality of acceleration protocols also can be preset in the operating system of the smart TV apparatus for selection by the user; when the target connection mode is the high-rate mode, the user can select to configure the network connection parameters by using the preset acceleration protocol; when the target connection mode is the stable mode, the user can select to clear or partially clear the network connection parameters corresponding to the acceleration protocol.

An acceleration mechanism can be realized by use of a Frame Aggregation technology; the technology can solve two problems of an MAC (Media Access Control) layer, namely reduction of throughput due to conflicts generated in channel competition and reduction of system throughput due to a backoff mechanism introduced for solving the conflicts.

The frame aggregation technology further contains Aggregation A-MSDU specific to MSDUs (MAC Server Data Units) and Aggregation-MPDU specific to MPDUs (MAC Protocol Data Units):

The A-MSDU technology aggregates a plurality of MSDUs into a great load in a certain manner. Here, MSDU can be an Ethernet message. Usually, when an AP (Access Point) or a wireless client receives messages (MSDU) from a protocol stack, it will label each message with an Ethernet message header, which is called A-MSDUSubframe; but before the messages are sent out through a radio-frequency port, the messages need to be converted into an 802.11 message format one by one. Besides, the A-MSDU technology aggregates a plurality of A-MSDUSubframes together and packages the same into an 802.11 message for transmission. As a result, overheads of PLCPPreambles, PLCPHeaders and 802.11MAC headers needed by transmitting each 802.11 message are reduced, and simultaneously, the number of response frames is also reduced and the efficiency of message transmission is improved.

It is MPDUs packaged as 802.11 messages that are aggregated by A-MPDU, wherein MPDU refers to a data frame packaged through 802.11. A plurality of MPDUs are transmitted once so that PLCPPreambles and PLCPHeaders needed by transmitting each 802.11 message are reduced, and therefore, the system throughput is improved.

Additionally, if the target connection mode selected by the user is the high-rate mode, in order to prevent overhigh load of the wireless router due to wrong selection of the user, whether the load of the router exceeds a set threshold can be detected after the network connection between the smart TV and the wireless router is re-established, and if it exceeds the set threshold, the user can be reminded of that, due to overhigh load of the router, the connection mode should be switched to the stable mode to adapt to the hardware environment of this router.

On the basis of a basic wireless communication protocol, the user can selectively add or delete the acceleration protocols, and therefore, the network performances can be changed more conveniently and quickly such that the requirements of the user can be met and also the current network performance can be enabled to match with hardware indices of the used wireless router to a best extent. In addition, the establishment of the load threshold of the router can effectively avoid damage to or service life shortening of the router in a long-term high-load environment.

The present disclosure also provides a communication protocol control device in a smart TV apparatus corresponding to the communication protocol control method; a plurality of communication protocols corresponding to a plurality of connection modes are preset in the smart TV apparatus; the device comprises:

a target communication protocol determination unit 201 for determining the target communication protocol corresponding to the target connection mode needing to be switched to when a mode switching request from a user is received through a preset user operation entry;

an interruption unit 202 for interrupting a current network connection between the smart TV apparatus and a router;

an application switching unit 203 for clearing a first application corresponding to the current communication protocol from a network card chip of the smart TV apparatus, and writing a second application corresponding to the target communication protocol in the network card chip of the smart TV apparatus;

a parameter configuration unit 204 for configuring network connection parameters of the smart TV apparatus by using the target communication protocol; and

a network connection establishment unit 205 for re-establishing the network connection between the smart TV apparatus and the router.

Additionally, to prevent overhigh load of the wireless router due to wrong selection of the user, the communication protocol control device further comprises:

a threshold detection unit and a reminding unit,

wherein when the target connection mode is the high-rate mode, and after the network connection unit re-establishes the network connection between the smart TV apparatus and the router,

the threshold detection unit detects whether the load of the router exceeds a set threshold; and

the reminding unit reminds the user of re-switching the connection mode to the stable mode if a judgment that the load exceeds the set threshold is made.

The communication protocol control device in the smart TV apparatus in the embodiment of the present disclosure can switch the wireless communication protocols according to requests from the user to match the hardware indices of the used wireless router. Overload of the old-style wireless router running under the high-rate communication protocol is avoided, and meanwhile, the high performance of the new-style router can be achieved.

With respect to various above-mentioned device embodiments, for the sake of simple description, they are expressed as a series of unit combinations; but those skilled in the art should know that the present disclosure is not limited by the described unit combinations because some units can be replaced with other units according to the present disclosure; second, those skilled in the art also should know the device embodiments are all preferred embodiments and the units involved therein are not necessary for the present disclosure.

Each embodiment in the description is described in a progressive manner, and in each embodiment, the differences between the embodiment and other embodiments are mainly explained; the same and similar parts of the various embodiments mutually refer to each other. System embodiments are just simply described because they are substantially similar to the method embodiments, and correlations therebetween just refer to one part of descriptions of the method embodiments.

The communication protocol control method and device in the smart TV apparatus provided by the present disclosure are described in detail above; herein, specific examples are utilized to explain the principles and the implementation manners of the present disclosure, and the foregoing descriptions of the embodiments are merely used for helping to understand the method of the present disclosure and the main ideas thereof; meanwhile, for those ordinary skilled in the art, alterations will be made to the specific implementation manners and the application range according to the thoughts of the present disclosure; in conclusion, the content of the description should not be understood as limitations to the present disclosure.

What is claimed is:

1. A communication protocol control method in a smart TV apparatus, wherein a plurality of communication protocols corresponding to a plurality of connection modes are preset in the smart TV apparatus; the method comprises:
when a mode switching request from a user is received through a preset user operation entry, determining the target communication protocol corresponding to the target connection mode needing to be switched to;
interrupting a current network connection between the smart TV apparatus and a router;
clearing a first application corresponding to the current communication protocol from a network card chip of the smart TV apparatus, and writing a second application corresponding to the target communication protocol in the network card chip of the smart TV apparatus;
configuring network connection parameters of the smart TV apparatus by using the target communication protocol; and
re-establishing the network connection between the smart TV apparatus and the router.

2. The method of claim 1, wherein before interrupting the current network connection between the smart TV apparatus and the router, the method further comprises:
obtaining user configuration information saved in the smart TV apparatus and needed by logging in the router;
the re-establishing the network connection between the smart TV apparatus and the router comprises:
re-establishing the network connection between the smart TV apparatus and the router according to the user configuration information.

3. The method of claim 1, wherein before interrupting the current network connection between the smart TV apparatus and the router, the method further comprises:
obtaining information of an application which is in a network communication through a wireless network at present in the smart TV apparatus and saving network operation data of the application;
the re-establishing the network connection between the smart TV apparatus and the router comprises:
re-loading the application according to the saved network operation data of the application.

4. The method of claim 1, wherein the connection modes include a stable mode and a high-rate mode, wherein the stable mode corresponds to a communication protocol suitable for low-rate transmission, while the high-rate mode corresponds to a communication protocol suitable for high-rate transmission.

5. The method of claim 4, wherein when the target connection mode is the high-rate mode, the network connection parameters are configured by using a preset acceleration protocol; when the target connection mode is the stable mode, the network connection parameters corresponding to the acceleration protocol are cleared.

6. The method of claim 4, wherein after re-establishing the network connection between the smart TV apparatus and the router when the target connection mode is the high-rate mode, the method further comprises:
detecting whether the load of the router exceeds a set threshold; and
if the load exceeds the set threshold, reminding the user of re-switching the connection mode to the stable mode.

7. A communication protocol control device in a smart TV apparatus, wherein a plurality of communication protocols corresponding to a plurality of connection modes are preset in the smart TV apparatus; the device comprises:
a target communication protocol determination unit for determining the target communication protocol corresponding to the target connection mode needing to be switched to when a mode switching request from a user is received through a preset user operation entry;
an interruption unit for interrupting a current network connection between the smart TV apparatus and a router;
an application switching unit for clearing a first application corresponding to the current communication protocol from a network card chip of the smart TV apparatus, and writing a second application corresponding to the target communication protocol in the network card chip of the smart TV apparatus;
a parameter configuration unit for configuring network connection parameters of the smart TV apparatus by using the target communication protocol; and
a network connection establishment unit for re-establishing the network connection between the smart TV apparatus and the router.

8. The device of claim 7, further comprising a user configuration information obtaining unit, wherein before the interruption unit interrupts the current network connection between the smart TV apparatus and the router,
the user configuration information obtaining unit obtains user configuration information saved in the smart TV apparatus and needed by logging in the router;
the network connection establishment unit re-establishes the network connection between the smart TV apparatus and the router according to the user configuration information obtained by the user configuration information obtaining unit.

9. The device of claim 7, further comprising an application information obtaining unit, wherein before the interruption unit interrupts the current network connection between the smart TV apparatus and the router:
the application information obtaining unit obtains information of an application which is in a network communication through a wireless network at present in the smart TV apparatus and saves network operation data of the application;
the network connection establishment unit is used for re-loading the application according to the network operation data of the application saved by the application information obtaining unit.

10. The device of claim 7, wherein the connection modes include a stable mode and a high-rate mode, wherein the stable mode corresponds to a communication protocol suitable for low-rate transmission, while the high-rate mode corresponds to a communication protocol suitable for high-rate transmission.

11. The device of claim 10, wherein when the target connection mode is the high-rate mode, the parameter configuration unit configures network connection parameters by using a preset acceleration protocol; when the target connection mode is the stable mode, the parameter configuration unit clears the network connection parameters corresponding to the acceleration protocol.

12. The device of claim 10, further comprising:
a threshold detection unit and a reminding unit,
wherein when the target connection mode is the high-rate mode, and after the network connection unit re-establishes the network connection between the smart TV apparatus and the router,
the threshold detection unit detects whether the load of the router exceeds a set threshold; and
the reminding unit reminds the user of re-switching the connection mode to the stable mode if a judgment that the load exceeds the set threshold is made.

13. A computer-readable recording medium on which a program for executing the method of claim 1 is recorded.
